(19) United States
(12) Patent Application Publication
(10) Pub. No.: US 2008/0006176 A1
(43) Pub. Date: Jan. 10, 2008

(54) Image forming apparatus and ink set

(75) Inventor: Hiroaki Houjou, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/819,456

(22) Filed: Jun. 27, 2007

(30) Foreign Application Priority Data
Jul. 10, 2006 (JP) 2006-189482

(51) Int. Cl. C09D 11/00; G03G 15/20

(52) U.S. Cl. 106/31.13; 399/308

(57) ABSTRACT

The image forming apparatus includes: an intermediate transfer body on which an ink image is formed; a treatment liquid application unit which applies treatment liquid on the intermediate transfer body; an ink ejection unit which ejects ink to be deposited on the treatment liquid to form the ink image; and a transfer unit which transfers the ink image formed on the intermediate transfer body to a recording medium, wherein: the ink contains coloring material and an emulsion of resin having an ionic group; the treatment liquid changes a pH of the ink when making contact with the ink so that the coloring material and the emulsion of resin having the ionic group aggregate; and a pH differential between the ink and the treatment liquid is not less than 3.

### BACKGROUND OF THE INVENTION

1. Field of the Invention

The present invention relates to an image forming apparatus and an ink set, and more particularly, to an intermediate transfer type of image forming apparatus and an ink set used in this apparatus, in which an image is formed on a recording medium by transferring an image (ink image) formed on an intermediate transfer body to the recording medium.

2. Description of the Related Art

There is known an image forming apparatus based on a so-called intermediate transfer system, in which an image is formed on an intermediate transfer body, and the image formed on the intermediate transfer body is then transferred to a recording medium. In this image forming apparatus, it has been difficult to achieve both high quality and high transferability of the image on the intermediate transfer body. This is because the intermediate transfer body producing high transferability (separation characteristics) is often made of material that basically has low surface energy and high liquid repelling properties, and therefore liquid flows are liable to arise on the intermediate transfer body, and hence image quality is liable to decline. In view of these circumstances, various methods have been proposed in order to achieve high image quality on the intermediate transfer body.

Japanese Patent Application Publication Nos. 2002-370441 and 2005-170036 disclose image forming methods based on the intermediate transfer system, which use an ink set composed of an ink containing coloring material particles, and a treatment liquid containing a component that causes aggregation of the coloring material particles in the ink. It is described that, according to these image forming methods, an image of high quality which is free of bleeding and feathering can be formed on the intermediate body and then transferred to the recording medium, and it is possible to obtain an image having excellent waterproofing characteristics and wear resistance. Moreover, Japanese Patent Application Publication No. 2002-370441 discloses that water-soluble resin having a minimum film-forming temperature (MFT) of 30° C. or lower is added to the ink or the treatment liquid so as to impart even greater wear resistance to the image. Furthermore, Japanese Patent Application Publication No. 2005-170036 discloses that water-soluble resin is applied on the image before transfer so as to impart wear resistance to the image.

However, in these image forming methods, since the cationic or anionic compound contained in the treatment liquid acts on the coloring material particles having opposite polarity for the aggregation (e.g., in Japanese Patent Application Publication No. 2005-170036, a metal salt causes aggregation of anionic coloring material particles), and in order to cause the whole of the coloring material particles to aggregate, the coloring material particles and the reactive component must be mixed together completely, which is problematic in that time is required to achieve sufficient mixing. Consequently, if image formation is carried out at high speed, then the image is conveyed to the transfer unit in a state where the coloring material particles have not yet sufficiently aggregated. Moreover, there is a problem that the un-aggregated coloring material particles may flow over the intermediate transfer body, thereby blemishing the image quality. Furthermore, it has been known that if the aggregation is not sufficient, then the application of the resin is not considerably effective in terms of the wear resistance.

Japanese Patent Application Publication No. 2003-82265 discloses that an ink contains an emulsion as well as coloring material particles as a component reacting with a reactive component of a treatment liquid, and the emulsion is constituted of resin particles having an ionic group on their surfaces and reacts with the reactive component of the treatment liquid. By means of the additional aggregating effects produced by cohesion of the resin emulsion component contained in the ink caused by the reactive component contained in the treatment liquid, the aggregating force in the aggregate of the coloring material particles is increased. However, this image forming method does not resolve the problem that the time enough to achieve the aggregating force sufficient for transfer is too long, and hence this method involves a similar problem in that it is not suitable to a high-speed system.

In the above-described two-liquid aggregating mechanism using the treatment liquid and the ink on the intermediate transfer body, the cationic reaction component (typically a polyvalent metal salt, an amine salt, or the like) contained in the treatment liquid is adsorbed on the coloring material particles dispersed in the ink, and thereby causes the aggregate. If the resin emulsion is included, the cationic reaction component is similarly adsorbed on the resin particles. When the treatment liquid and the ink come into contact, this adsorption occurs on the contact interface between the treatment liquid and the ink, and an aggregate is generated on the contact interface. A film formed of the aggregate then impedes the movement of the cationic reaction component of the treatment liquid, into the ink. Hence, it takes time for the treatment liquid and the ink to become uniformly mixed together, and therefore the aggregation occurs principally in the vicinity of the interface between the treatment liquid and the ink, and the reaction in the whole of the mixture of ink and the treatment liquid does not complete before transfer of the image. Therefore, during the transfer, the coloring material particles move and the dot shapes are disrupted since the fluidity of the mixed liquid is still high. Moreover, due to the inadequate aggregating force of the aggregate of the coloring material particles, the aggregate separates during the transfer, giving rise to transfer defects, such as offset, transfer irregularities, and the like. In this case, even if the resin emulsion is added, ultimately, it hardly produces any beneficial effects.

### SUMMARY OF THE INVENTION

The present invention has been contrived in view of the foregoing circumstances, an object thereof being to provide an image forming apparatus of an intermediate transfer type, and an ink set, which improve image quality on the intermediate transfer body, as well as making it possible to transfer an image formed on the intermediate transfer body, to a recording medium., satisfactorily and at high-speed.

In order to attain the aforementioned object, the present invention is directed to an image forming apparatus, comprising: an intermediate transfer body on which an ink image is formed; a treatment liquid application unit which applies treatment liquid on the intermediate transfer body; an ink ejection unit which ejects ink to be deposited on the treatment liquid to form the ink image; and a transfer unit which transfers the ink image formed on the intermediate transfer body to a recording medium, wherein: the ink contains coloring material and an emulsion of resin having an ionic group; the treatment liquid changes a pH of the ink when making contact with the ink so that the coloring material and the emulsion of resin having the ionic group aggregate; and a pH differential between the ink and the treatment liquid is not less than 3.

According to this aspect of the present invention, in the image forming apparatus of the intermediate transfer type, since there is the pH differential of 3 or above between the ink containing the coloring material and the emulsion of resin having the ionic group, and the treatment liquid which induces a pH change by making contact with the ink and produces an aggregating action in the coloring material and the emulsion of resin having the ionic group, then the image quality on the intermediate transfer body is improved, and it is possible to transfer the image on the intermediate transfer body to the recording medium, satisfactorily and at high speed.

More specifically, the treatment liquid and the ink come into contact with each other, the salt in the treatment liquid tends to move from the treatment liquid into the ink by diffusion due to the concentration gradient, and the coloring material and the resin particles in the ink similarly tend to move from the ink into the treatment liquid due to the concentration gradient. In this case, the pH of the treatment liquid and the pH of the ink suddenly change, the whole of the ink is neutralized swiftly from the vicinity of the interface, and the suspension of the coloring material particles and the resin particles in the ink is thereby destabilized and an aggregate is formed in which the coloring material particles and the resin particles contained in the ink are combined. Here, the destabilization of the suspension of the coloring material particles and the resin particles in the ink is caused by the salt diffusing from the treatment liquid, in which the ions derived from the salt neutralize the anions on the surface of the coloring material particles and the resin particles and thereby reduce the surface charge of the coloring material particles and the resin particles, so that the repulsive forces between the coloring material particles and the resin particles are removed. The ions constituting the salt in the treatment liquid have a small size and can therefore pass through the aggregation layer formed around the interface, and it is possible to make the speed of aggregation sufficiently fast.

Consequently, in addition to improving the image quality on the intermediate transfer body, it is also possible to achieve good transfer from the intermediate transfer body to the recording medium, even when using a high-speed system. Moreover, it is possible to achieve good ink fixing properties and good gloss, on the recording medium. Therefore, no residual material is left on the intermediate transfer body after the transfer and it is possible to reduce the load of cleaning the intermediate transfer body after the transfer.

The method of applying the treatment liquid by means of the treatment liquid application unit according to the present invention is not limited to ejecting the treatment liquid in the form of droplets by means of an ejection head, and the intermediate transfer body may be coated with the treatment liquid by means of a coating method. Moreover, for the ink ejection unit, it is suitable to use an inkjet head which ejects ink liquid on the basis of image information for printing (print data). In the present specification, the term “recording medium” does not only mean paper used in a general apparatus, but may also include cloth, metal, sheet material, glass, ceramic, wood, plastic film, leather, or the like.

Preferably, the image forming apparatus further comprises a solvent removal unit which removes solvent from the ink image formed on the intermediate transfer body.

According to this aspect of the present invention, by providing the solvent removal unit, it is possible to remove excess solvent from the ink aggregate, and therefore it is possible to concentrate the aggregate and to increase the internal aggregating force yet further. Consequently, the cohesion of the resin particles contained in the aggregate is promoted, and therefore a stronger internal aggregating force can be achieved in the aggregate.

The solvent removal unit does not necessarily have to remove all of the solvent from the ink aggregate.

Preferably, the transfer unit includes a heating device.

According to this aspect of the present invention, by heating the ink aggregate by means of the heating device in the transfer unit, then the cohesion of the resin particles contained in the aggregate is promoted, and a stronger internal aggregating force can be achieved in the ink aggregate.

Preferably, a heating temperature in the transfer unit is not lower than a minimum film formation temperature of the emulsion of resin having the ionic group.

According to this aspect of the present invention, by heating the ink aggregate to the minimum film formation temperature (MFT) of the emulsion of resin having the ionic group or higher, it is possible dramatically to accelerate the cohesion of the resin particles due to heating during transfer, in comparison with a case where it is heated to a temperature below the minimum film formation temperature.

Preferably, the recording medium is heated to a temperature not lower than a minimum film formation temperature of the emulsion of resin having the ionic group, before being conveyed to the transfer unit.

According to this aspect of the present invention, by setting the heating temperature of the recording medium to the minimum film formation temperature (MFT) of the emulsion of resin having the ionic group or higher, it is possible to accelerate, more dramatically, the cohesion of the resin particles due to heating during transfer. Moreover, due to the surface of the recording medium being heated in advance to the MFT or higher, when the ink aggregate comes into contact with the surface of the recording medium during the transfer-nipping, the ink aggregate quickly melts and flows into depressions or capillaries on the surface of the recording medium, thereby increasing the adhesiveness of the ink aggregate onto the recording medium due to the anchor effects caused by the increase in contact area, and consequently, the transfer is performed satisfactorily and after the transfer, it is possible to achieve good fixing characteristics in the image.

Preferably, a minimum film formation temperature of the emulsion of resin having the ionic group is not higher than 70° C.

According to this aspect of the present invention, since the minimum film formation temperature (MFT) of the emulsion of resin having the ionic group is 70° C. or lower, then it is possible dramatically to accelerate the cohesion of the resin due to heating during transfer. The MFT of the emulsion of resin contained in the ink is desirably not higher than 70° C., more desirably not higher than 50° C., and even more desirably not higher than 30° C. The lower the MFT, the lower the heating temperature required in the transfer unit, and thus achieving transfer at low temperature.

In order to attain the aforementioned object, the present invention is also directed to an ink set for an image forming apparatus of an intermediate transfer type which forms an image on a recording medium by forming an ink image on an intermediate transfer body and then transferring the ink image formed on the intermediate transfer body to the recording medium, the ink set comprising: an ink which contains coloring material and an emulsion of resin having an ionic group; and a treatment liquid which changes a pH of the ink when making contact with the ink so that the coloring material and the emulsion of resin having the ionic group aggregate, wherein a pH differential between the ink and the treatment liquid is not less than 3.

According to this aspect of the present invention, it is also possible to provide an ink set for use in an image forming apparatus of an intermediate transfer type, whereby, as well as improving the image quality on the intermediate transfer body, it is also possible to transfer the image formed on the intermediate transfer body to the recording medium, satisfactorily and at high speed.

Preferably, a minimum film formation temperature of the emulsion of resin having the ionic group is not higher than 70° C.

According to this aspect of the present invention, since the minimum film formation temperature (MFT) of the emulsion of resin having the ionic group is 70° C. or lower, then it is possible dramatically to accelerate the cohesion of the resin due to heating during transfer.

According to the present invention, it is possible to provide an image forming apparatus of an intermediate transfer type and an ink set for the apparatus, whereby, as well as improving the image quality on the intermediate transfer body, it is also possible to transfer the image formed on the intermediate transfer body to the recording medium, satisfactorily and at high speed.

### BRIEF DESCRIPTION OF THE DRAWINGS

The nature of this invention, as well as other objects and advantages thereof, will be explained in the following with reference to the accompanying drawings, in which reference characters designate the same or similar parts throughout the figures and wherein:

FIG. 1 is a general schematic drawing showing a general view of an inkjet recording apparatus according to an embodiment of the present invention;

FIG. 2 is a plan diagram showing an ejection face of a recording head;

FIG. 3 is a partial cross-sectional diagram along line 3-3 in FIG. 2;

FIG. 4 is a principal block diagram showing the system composition of the inkjet recording apparatus; and

FIG. 5 is a table of experimental results concerning examples of the present invention and comparative examples.

### DETAILED DESCRIPTION OF THE PREFERRED EMBODIMENTS

An image forming apparatus according to an embodiment of the present invention includes: an intermediate transfer body, which carries an ink image; a treatment liquid application unit, which applies treatment liquid on the intermediate transfer body; an ink ejection unit, which ejects ink toward the treatment liquid formed on the intermediate transfer body; and a transfer unit, which transfers the ink image formed on the intermediate transfer body, to a recording medium. The ink contains coloring material particles and an emulsion constituted of resin particles having an ionic group, the treatment liquid creates a pH change by making contact with the ink, and an aggregating action is generated in the coloring material particles and the resin particles having the ionic group. The pH differential between the ink and the treatment liquid is 3 or greater.

Firstly, the treatment liquid and the ink are described in detail.

### Treatment Liquid

The treatment liquid in the present embodiment contains a pH aggregating agent, water, water-soluble organic solvent, as well as other additives.

The pH aggregating agent described here is a material that has the beneficial effects of generating aggregation or increased viscosity, by producing a pH change in the ink when coming into contact with the ink. Examples of the pH aggregating agent containable in the treatment liquid include: an inorganic electrolyte such as an alkali metal salt; and an organic acid, such as an organic carboxylic acid, and an organic sulfonic acid.

Specific examples of the pH aggregating agent are: 2-pyrrolidone-5-carboxylic acid, 4-methyl-4-pentanolide-3-carboxylic acid, furan carboxylic acid, 2-benzofuran carboxylic acid, 5-methyl-2-furan carboxylic acid, 2,5-dimethyl-3-furan carboxylic acid, 2,5-furan dicarboxylic acid, 4-butanolide-3-carboxylic acid, 3-hydroxy-4-pyrone-2,6-dicarboxylic acid, 2-pyrone-6-carboxylic acid, 4-pyrone-2-carboxylic acid, 5-hydroxy-4-pyrone-5-carboxylic acid, 4-pyrone-2,6-dicarboxylic acid, 3-hydroxy-4-pyrone-2,6-dicarboxylic acid, thiophene carboxylic acid, 2-pyrrole carboxylic acid, 2,3-dimethyl pyrone-4-carboxylic acid, 2,4,5-trimethyl pyrrole-3-propionic acid, 3-hydroxy-2-indole carboxylic acid, 2,5-dioxy-4-methyl-3-pyrroline-3-propionic acid, 2-pyrrolidone carboxylic acid, 4-hydroxyproline, 1-methyl pyrrolidine-2-carboxylic acid, 5-carboxyl-1-methyl pyrrolidine-2-acetate, 2-pyridine carboxylic acid, 3-pyridine carboxylic acid, 4-pyridine carboxylic acid, pyridine dicarboxylic acid, pyridine tricarboxylic acid, pyridine pentacarboxylic acid, 1,2,5,6-tetrahydro-1-methyl nicotinic acid, 2-quinoline carboxylic acid, 4-quinoline carboxylic acid, 2-phenyl-4-quinoline carboxylic acid, 4-hydroxy-2-quinoline carboxylic acid, 6-methoxy-4-quinoline carboxylic acid, potassium hydrogen phthalate, potassium dihydrogen phosphate, boric acid, sodium citrate, potassium citrate, sodium tetraborate, tartaric acid, lactic acid, ammonium chloride, sodium hydroxide, potassium hydroxide, hydrochloric acid, derivatives of these compounds, and salts of these.

Desirable examples of the pH aggregating agent are: pyrrolidone carboxylic acid, pyrone carboxylic acid, pyrrole carboxylic acid, furan carboxylic acid, pyridine carboxylic acid, cumaric acid, thiophene carboxylic acid, nicotinic acid, potassium dihydrogen citrate, succinic acid, tartaric acid, lactic acid, potassium hydrogen phthalate, derivatives of these compounds, and salts of these. More desirable examples of the pH aggregating agent are: pyrrolidone carboxylic acid, pyrone carboxylic acid, furan carboxylic acid, cumaric acid, derivatives of these compounds, and salts of these.

It is desirable in the present embodiment that the added amount of the pH aggregating agent in the treatment liquid is no less than 0.01 wt % and no more than 20 wt % with respect to the total weight of the liquid. If the added amount is less than 0.01 wt %, then when the treatment liquid and the ink come into contact, the concentration difflusion may not progress satisfactorily and the aggregating action caused by the pH change may not occur satisfactorily. On the other hand, if the added amount is greater than 20 wt %, then the ejection characteristics from the ejection head may deteriorate.

It is desirable in the present embodiment that the pH of the treatment liquid is adjusted to 3 through 6, from the viewpoint of the pH aggregating characteristics with respect to the ink.

It is desirable in the present embodiment that the treatment liquid contains an aqueous organic solvent, or other additives, from the viewpoint of preventing nozzle blockages in the ejection head due to drying. Examples of the water-soluble organic solvent or other additives include a wetting agent and a penetrating agent.

Examples of the water-soluble organic solvent include: polyhydric alcohols, polyhydric alcohol derivatives, nitrous solvents, monohydric alcohols, and sulfurous solvents. Specific examples of the polyhydric alcohols are: ethylene glycol, diethylene glycol, propylene glycol, butylene glycol, triethylene glycol, 1,5-pentane diol, 1,2,6-hexane triol, and glycerin. Specific examples of the derivatives of polyhydric alcohol are: ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and an ethylene oxide adduct of diglycerin. Specific examples of the nitrous solvents are: pyrrolidone, N-methyl-2-pyrrolidone, cyclohexyl pyrrolidone, and triethanol amine. Specific examples of the monohydric alcohols are: ethanol, isopropyl alcohol, butyl alcohol, benzyl alcohol, and the like. Specific examples of the sulfurous solvents are: thio diethanol, thio diglycerol, sulfolane, and dimethyl sulfoxide. Apart from these, it is also possible to use propylene carbonate, ethylene carbonate, or the like.

In the present embodiment, a single type of the water-soluble organic solvent may be used independently, or two or more types of the water-soluble organic solvents may be mixed and used together. The content ratio of water-soluble organic solvent and other additives to the total weight of the treatment liquid is desirably no more than 60 wt %. If the content ratio is greater than 60 wt %, then the viscosity of the treatment liquid may increase and the ejection characteristics from the ejection head may deteriorate.

It is also possible to add a resin component to the treatment liquid in order to improve the fixing characteristics. The resin component may be any resin that has stable storage characteristics, and that does not impair the ejection characteristics from the ejection head if the treatment liquid is ejected in the form of droplets from the ejection head, and it is possible freely to choose a water-soluble resin, resin emulsion, or the like.

In order to improve the aggregating characteristics, it is possible that the treatment liquid contains a resin having a polarity opposite to the coloring material particles in the ink, so as to cause the resin and the coloring material particles in the ink to aggregate.

Moreover, in order to improve the aggregating characteristics, it is possible that the treatment liquid contains a curing agent corresponding to a resin emulsion component contained in the ink, so that when the treatment liquid and the ink come into contact with each other, the resin emulsion component in the ink is cross-linked or polymerized and aggregates.

The treatment liquid according to the present embodiment may contain a surface active agent.

Desirable examples of the surface active agent include: in a hydrocarbon system, an anionic surface active agent, such as a salt of a fatty acid, an alkyl sulfate ester salt, an alkyl benzene sulfonate salt, an alkyl naphthalene sulfonate salt, a dialkyl sulfosuccinate salt, an alkyl phosphate ester salt, a naphthalene sulfonate/formalin condensate, and a polyoxyethylene alkyl sulfonate ester salt; and a non-ionic surface active agent, such as a polyoxyethylene alkyl ether, a polyoxyethylene alkyl aryl ether, a polyoxyethylene fatty acid ester, a sorbitan fatty acid ester, a polyoxyethylene sorbitan fatty acid ester, a polyoxyethylene alkyl amine, a glycerin fatty acid ester, and an oxyethylene oxypropylene block copolymer. Desirable examples of the surface active agent further include: Surfynols (manufactured by Air Products & Chemicals), which is an acetylene-based polyoxyethylene oxide surface active agent, and an amine oxide type of amphoteric surface active agent, such as N,N-dimethyl-N-alkyl amine oxide.

Moreover, it is also possible to use the surface active agents cited in Japanese Patent Application Publication No. 59-157636, pages 37 to 38, and Research Disclosure No. 308119 (1989). Furthermore, it is also possible to use a fluoride type (alkyl fluoride type), or silicone type of surface active agent such as those described in Japanese Patent Application Publication Nos. 2003-322926, 2004-325707 and 2004-309806. It is also possible to use a surface tension adjuster of this kind as an anti-foaming agent; and a fluoride or silicone compound, or a chelating agent, such as ethylenediamine tetraacetic acid (EDTA), can also be used.

The surface active agent contained in the treatment liquid has beneficial effects in raising the wetting properties on the intermediate transfer body by reducing the surface tension. Similarly, in the case where the ink droplets are deposited in advance, the wetting properties on the ink are improved, and therefore the aggregating action effectively progresses due to the increase in the contact surface area between the treatment liquid and the ink.

It is desirable in the present embodiment that the treatment liquid has the surface tension of 10 mN/m through 50 mN/m; and from the viewpoint of achieving good wetting properties on the intermediate transfer body, formation of fine droplets and good ejection properties, the surface tension of the treatment liquid is more desirably 15 mN/m through 45 mN/m.

It is desirable in the present embodiment that the treatment liquid has the viscosity of 1.0 mPa·s through 20.0 mPa·s.

Apart from the foregoing, according to requirements, it is also possible that the treatment liquid contains a pH buffering agent, an anti-oxidation agent, an antibacterial agent, a viscosity adjusting agent, a conductive agent, an ultraviolet absorbing agent, or the like.

The method of depositing the treatment liquid is not limited to the ejection method, and there are no particular restrictions on the type of depositing method, for instance, the treatment liquid may be deposited by application with a coating method.

### Ink

The ink for inkjet recording in the present embodiment contains a coloring material, a resin emulsion, a water-soluble organic solvent, and water.

The coloring material in the ink may be a dye, a pigment or a combination of these. From the viewpoint of the aggregating characteristics when the ink comes into contact with the treatment liquid, a dispersed pigment in the ink is desirable for more effective aggregation. Desirable pigments include: a pigment dispersed by a dispersant, a self-dispersing pigment, a pigment in which the surface of coloring material particles are covered by resin, and a polymer grafted pigment. Moreover, from the viewpoint of the aggregating characteristics of the coloring material, it is more desirable that the coloring material is modified with a carboxylic acid group having a low degree of disassociation.

There are no particular restrictions on the pigment used in the present embodiment, and specific examples of orange and yellow pigments are: C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 74, C. I. Pigment Yellow 93, C. I. Pigment Yellow 94, C. I. Pigment Yellow 128, C. I. Pigment Yellow 138, C. I. Pigment Yellow 151, C. I. Pigment Yellow 155, C. I. Pigment Yellow 180, and C.I. Pigment Yellow 185.

Specific examples of red and magenta pigments are: C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178, and C.I. Pigment Red 222.

Specific examples of green and cyan pigments are: C. I. Pigment Blue 15, C. I. Pigment Blue 15:2, C. I. Pigment Blue 15:3, C. I. Pigment Blue 16, C. I. Pigment Blue 60, and C.I. Pigment Green 7.

Specific examples of a black pigment are: C.I. Pigment Black 1, C.I. Pigment Black 6, and C.I. Pigment Black 7.

The concentration of the coloring material contained in the ink in the present embodiment is set to an appropriate value in accordance with the coloring material used. The percentage of the coloring material in the ink is preferably 0.1 wt % through 40 wt %, more desirably 1 wt % through 30 wt %, and even more desirably 2 wt % through 20 wt %.

It is desirable in the present embodiment that the ink contains a resin emulsion that does not contain any colorant, as a component for reacting with the treatment liquid. The resin emulsion can improve the image quality by strengthening the ink viscosity raising action and the aggregating action through reaction with the treatment liquid. In particular, a highly stable ink can be obtained by adding a resin emulsion in which anionic resin particles are dispersed, to the ink. By using the ink containing the resin emulsion that produces the viscosity raising action and the aggregating action through reaction with the treatment liquid, it is possible to increase the quality of the image on the transfer body, and at the same time, depending on the type of resin emulsion, the resin emulsion may form a film on the recording medium, and therefore beneficial effects can be obtained in improving the wear resistance, the light resistance and the waterproofing characteristics of the image.

The method of dispersing the resin particles in the ink is not limited to adding the emulsion to the ink, and the resin may also be dissolved, or included in the form of a colloidal dispersion, in the ink.

The resin emulsion may be one in which the resin particles are dispersed by using an emulsifier, or one in which the resin particles are dispersed without using any emulsifier. For the emulsifier, a surface active agent of low molecular weight is generally used, and it is also possible to use a surface active agent of high molecular weight. It is also desirable to use a resin emulsion containing capsule type resin particles having an outer shell composed of acrylic acid, methacrylic acid, or the like (core-shell type of resin particles in which the composition is different between the core portion and the outer shell portion).

The resin emulsions without any surface active agent of low molecular weight are known as the soap-free emulsion, which includes resin emulsions with no emulsifier or a surface active agent of high molecular weight. For example, the soap-free emulsion includes a resin emulsion that uses, as an emulsifier, the above-described polymer having a water-soluble group, such as a sulfonic acid group or carboxylic acid group (a polymer with a grafted water-soluble group, or a block polymer obtained from a monomer having a water-soluble group and a monomer having an insoluble part).

It is especially desirable in the present embodiment to use the soap-free emulsion compared to other type of resin emulsion obtained by polymerization using an emulsifier, since there is no possibility that the emulsifier inhibits the aggregating reaction and film formation of the resin particles, or that the free emulsifier moves to the surface after film formation of the resin particles and thereby degrades the adhesive properties between the recording medium and the ink aggregate in which the coloring material and the resin particles are combined.

Furthermore, from the viewpoint of the aggregation characteristics of the resin particles, it is more desirable to use resin particles containing a carboxylic acid group having a low degree of disassociation.

The resin particles dispersed in the ink as emulsion aggregate due to a pH change caused by the treatment liquid, so that the resin particles encapsulate the coloring material particles and form an aggregate in which the resin particles and the coloring material particles are combined, and consequently the speed of aggregation of the coloring material is increased. Therefore, since the structure of the resin particles upon aggregation strongly affects the speed of aggregation, then the resin emulsion containing the resin particles having an optimal particle size, molecular weight, and other properties, is selected in accordance with type of the coloring material.

Examples of the resin component added as the resin emulsion to the ink include: an acrylic resin, a vinyl acetate resin, a styrene-butadiene resin, a vinyl chloride resin, an acryl-styrene resin, a butadiene resin, and a styrene resin. It is desirable that the resin component is a polymer having both a hydrophilic part and a hydrophobic part. Moreover, there is no particular restriction on the size of the resin particles, provided that the resin particles can be dispersed as emulsion, and the particle size is desirably approximately 200 nm or less, and more desirably 1 nm through 150 nm. Examples of commercially available resin emulsion include: Joncryl 537 and 7640 (styrene-acrylic resin emulsion, manufactured by Johnson Polymer), Microgel E-1002 and E-5002 (styrene-acrylic resin emulsion, manufactured by Nippon Paint), Voncoat 4001 (acrylic resin emulsion, manufactured by Dainippon Ink and Chemicals), Voncoat 5454 (styrene-acrylic resin emulsion, manufactured by Dainippon Ink and Chemicals), SAE-1014 (styrene-acrylic resin emulsion, manufactured by Zeon Japan), Jurymer ET-410 (acrylic resin emulsion, manufactured by Nihon Junyaku), Aron HD-5 and A-104 (acrylic resin emulsion, manufactured by Toa Gosei), Saibinol SK-200 (acrylic resin emulsion, manufactured by Saiden Chemical Industry), and Zaikthene L (acrylic resin emulsion, manufactured by Sumitomo Seika Chemicals). However, the resin emulsion is not limited to these examples.

In the present embodiment, an aggregate is formed in which the coloring material particles and the resin particles are combined, and therefore, the aggregating force becomes stronger than the internal aggregating force of an aggregate formed by the coloring material particles alone, and hence the transfer characteristics are improved. Moreover, since the coloring material particles and the resin particles aggregate together in a highly dense state, then it is possible to impart good gloss to the formed image, and hence the impression of a high-quality image can be conveyed to users.

The weight ratio of the resin emulsion to the coloring material is desirably 2:1 through 1:3, and more desirably 1:1 through 1:2. If the weight ratio of the resin emulsion to the coloring material is less than 2:1, then there is no substantial improvement in the aggregating force of the aggregate formed by the cohesion of the resin particles. On the other hand, if the weight ratio of the resin emulsion to the coloring material is greater than 1:3, the viscosity of the ink becomes too high and the ejection characteristics, and the like, deteriorate.

The minimum film formation temperature (MFT) of the resin emulsion added to the ink is desirably 70° C. or lower, more desirably 50° C. or lower, and even more desirably 30° C. or lower. If the minimum film formation temperature of the resin emulsion is 30° C. or lower, then it is possible for cohesion of the resin to proceed at room temperature, thereby imparting further wear resistance. If the minimum film formation temperature of the resin emulsion is higher than 70° C., then the thermal load in the transfer becomes extremely high. Moreover, a lower minimum film formation temperature is more beneficial in order to achieve sufficient heat conduction to the ink aggregate in the resin in the short time period during the transfer, and to impart a sufficient aggregating force to prevent the occurrence of any transfer errors. The same applies to a case where a fixing unit is provided on the intermediate transfer body and the fixing unit carries out a fixing step. The temperature characteristics, such as the glass transition temperature (Tg) and the minimum film formation temperature (MFT) of the resin can be appropriately adjusted by selecting monomers used for copolymerization of the resin.

From the viewpoint of the adhesive force after the cohesion, it is desirable that the molecular weight of the resin emulsion added to the ink is no less than 5,000 and no more than 200,000. If it is less than 5,000, then beneficial effects are insufficient in terms of improving the internal aggregating force of the ink aggregate, and achieving good fixing characteristics after transfer to the recording medium. On the other hand, if it is greater than 200,000, then the ejection characteristics from the ejection head deteriorate, and there is a concern that this may cause problems such as nozzle blockages.

Examples of the pH adjuster added to the ink in the present embodiment include an organic base and an inorganic alkali base, as a neutralizing agent. In order to improve storage stability of the ink for inkjet recording, the pH adjuster is desirably added in such a manner that the ink for inkjet recording has the pH of 6 through 10.

It is desirable in the present embodiment that the ink contains a water-soluble organic solvent, from the viewpoint of preventing nozzle blockages in the ejection head due to drying. Examples of the water-soluble organic solvent include a wetting agent and a penetrating agent.

Similarly to the case of the treatment liquid, examples of the water-soluble organic solvent in the ink are: polyhydric alcohols, polyhydric alcohol derivatives, nitrous solvents, monohydric alcohols, and sulfurous solvents. Specific examples of the polyhydric alcohols are: ethylene glycol, diethylene glycol, propylene glycol, butylene glycol, triethylene glycol, 1,5-pentane diol, 1,2,6-hexane triol, and glycerin. Specific examples of the derivatives of polyhydric alcohol are: ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and an ethylene oxide adduct of diglycerin. Specific examples of the nitrous solvents are: pyrrolidone, N-methyl-2-pyrrolidone, cyclohexyl pyrrolidone, and triethanol amine. Specific examples of the monohydric alcohols are: ethanol, isopropyl alcohol, butyl alcohol, benzyl alcohol, and the like. Specific examples of the sulfurous solvents are: thio diethanol, thio diglycerol, sulfolane, and dimethyl sulfoxide. Apart from these, it is also possible to use propylene carbonate, ethylene carbonate, or the like.

The ink according to the present embodiment may contain a surface active agent.

Similarly to the case of the treatment liquid, examples of the surface active agent in the ink include: in a hydrocarbon system, an anionic surface active agent, such as a salt of a fatty acid, an alkyl sulfate ester salt, an alkyl benzene sulfonate salt, an alkyl naphthalene sulfonate salt, a dialkyl sulfosuccinate salt, an alkyl phosphate ester salt, a naphthalene sulfonate/formalin condensate, and a polyoxyethylene alkyl sulfonate ester salt; and a non-ionic surface active agent, such as a polyoxyethylene alkyl ether, a polyoxyethylene alkyl aryl ether, a polyoxyethylene fatty acid ester, a sorbitan fatty acid ester, a polyoxyethylene sorbitan fatty acid ester, a polyoxyethylene alkyl amine, a glycerin fatty acid ester, and an oxyethylene oxypropylene block copolymer. Desirable examples of the surface active agent further include: Surfynols (manufactured by Air Products & Chemicals), which is an acetylene-based polyoxyethylene oxide surface active agent, and an amine oxide type of amphoteric surface active agent, such as N,N-dimethyl-N-alkyl amine oxide.

Moreover, it is also possible to use the surface active agents cited in Japanese Patent Application Publication No. 59-157636, pages 37 to 38, and Research Disclosure No. 308119 (1989). Furthermore, it is also possible to use a fluoride type (alkyl fluoride type), or silicone type of surface active agent such as those described in Japanese Patent Application Publication Nos. 2003-322926, 2004-325707 and 2004-309806. It is also possible to use a surface tension adjuster of this kind as an anti-foaming agent; and a fluoride or silicone compound, or a chelating agent, such as ethylenediamine tetraacetic acid (EDTA), can also be used.

The surface active agent contained in the ink has beneficial effects in raising the wetting properties on the intermediate transfer body or on the treatment liquid by reducing the surface tension, and therefore the aggregating action effectively progresses due to the increase in the contact surface area between the treatment liquid and the ink.

It is desirable in the present embodiment that the ink has the surface tension of 10 mN/m through 50 mN/m; and from the viewpoint of achieving good wetting properties on the intermediate transfer body or the treatment liquid, formation of fine droplets and good ejection properties, the surface tension of the ink is more desirably 15 mN/m through 45 mN/m.

It is desirable in the present embodiment that the ink has the viscosity of 1.0 mPa·s through 20.0 mPa·s.

Apart from the foregoing, according to requirements, it is also possible that the ink contains a pH buffering agent, an anti-oxidation agent, an antibacterial agent, a viscosity adjusting agent, a conductive agent, an ultraviolet absorbing agent, or the like.

### Inkjet Recording Apparatus

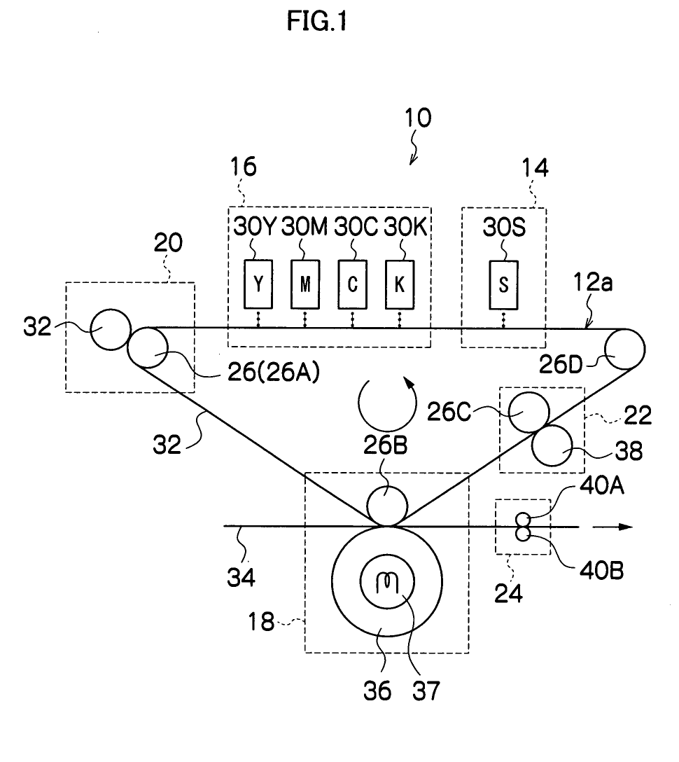

FIG. 1 is a schematic drawing which shows the approximate composition of the inkjet recording apparatus according to the present embodiment. As shown in FIG. 1, the inkjet recording apparatus 10 according to the present embodiment includes: an intermediate transfer body 12, a treatment liquid ejection unit 14, an ink ejection unit 16 and a transfer unit 18; and also has a solvent removal unit 20, a cleaning unit 22 and an image fixing unit 24.

The intermediate transfer body 12 is constituted of an endless belt having a prescribed width, and it is wound about a plurality of rollers 26. In the present embodiment, for example, four rollers 26A to 26D are used. There are also modes which use a drum-shaped member and a plate-shaped member as the intermediate transfer body 12.

The driving force of a motor (not illustrated) is transmitted to at least one main roller of the plurality of rollers 26, and by driving this motor, the intermediate transfer body 12 is caused to rotate about the outer side of the rollers 26 (26A to 26D) in the counter-clockwise direction in FIG. 1 (hereinafter, called the “direction of rotation of the intermediate transfer body”).

A recording head (treatment liquid head) 30S corresponding to the treatment liquid (S) is provided in the treatment liquid ejection unit 14. The treatment liquid head 30S ejects treatment liquid from an ejection face which opposes the intermediate transfer body 12. Accordingly, the treatment liquid is deposited onto the recording surface 12a of the intermediate transfer body 12.

The ink ejection unit 16 is disposed on the downstream side of the treatment liquid ejection unit 14 in terms of the direction of rotation of the intermediate transfer body. The ink ejection unit 16 includes recording heads (ink heads) 30K, 30C, 30M and 30Y corresponding respectively to the inks of the colors of black (K), cyan (C), magenta (M) and yellow (Y). The ink heads 30K, 30C, 30M and 30Y respectively eject inks of the corresponding colors, from ejection faces which oppose the intermediate transfer body 12. Accordingly, the inks of respective colors are deposited onto the recording surface 12a of the intermediate transfer body 12.

The treatment liquid head 30S and the ink heads 30K, 30C, 30M and 30Y are all full line heads formed with a plurality of ejection ports (nozzles) through the maximum recordable width of an image formed on the intermediate transfer body 12. This makes it possible to records images at higher speed onto the intermediate transfer body 12, compared to a serial head which records by moving a short shuttle head back and forth reciprocally in the breadthways direction of the intermediate transfer body 12 (the direction of the obverse-reverse of the sheet containing FIG. 1). Of course, the present invention can also be applied suitably to a serial head system that is capable of relatively high-speed recording, for example, a one-pass recording system which forms one line by means of one scan.

In the present embodiment, all of the recording heads (the treatment liquid head 30S, the ink heads 30K, 30C, 30M and 30Y) have the same structure, and below, a representative example of the recording heads is denoted with the reference numeral 30. The mechanism of the recording head 30 is described hereinafter. The implementation of the present invention is not limited to a case where the recording heads all have the same structure, and it is possible, for example, for the treatment liquid head 30S and the ink heads 30K, 30C, 30M and 30Y to have separate structures.

When the treatment liquid has been deposited from the treatment liquid head 30S onto the intermediate transfer body 12, then due to the rotation of the intermediate transfer body 12, the region of the intermediate transfer body 12 on which the treatment liquid has been deposited is moved successively to positions directly below the ink heads 30K, 30C, 30M and 30Y, and the corresponding inks of the respective colors are deposited from the ink heads 30K, 30C, 30M and 30Y As described above, the treatment liquid has a function of causing the solvent-insoluble material (coloring material, etc.) in the inks to aggregate.

More specifically, when the droplets of the treatment liquid are deposited on the intermediate transfer body and the ink droplets are then deposited on the deposited treatment liquid, the treatment liquid and the ink come into contact with each other, and the salt contained in the treatment liquid diffuses into the ink due to the concentration gradient while the coloring material particles and the resin particles in the ink diffuse into the treatment liquid due to the concentration gradient. Then, the pH of the treatment liquid and the ink suddenly changes and the neutralization in the ink quickly progresses from the vicinity of the interface with the treatment liquid, the suspension of the coloring material particles and the resin particles in the ink is thereby destabilized, and consequently an aggregate in which the coloring material particles and the resin particles are combined is formed. The destabilization of the suspension of the coloring material particles and the resin particles in the ink is caused by the salt diffusing from the treatment liquid, in which the ions derived from the salt neutralize the anions on the surface of the coloring material particles and the resin particles and thereby reduce the surface charge of the coloring material particles and the resin particles, so that the repulsive forces between the coloring material particles and the resin particles are removed. The ions constituting the salt in the treatment liquid have a small size and can therefore pass through the aggregation layer formed around the interface, and it is possible to sufficiently increase the speed of aggregation.

Thus, the inks deposited on the intermediate transfer body 12 assume a high viscosity by reacting with the treatment liquid, thereby preventing depositing interference between ink droplets of the same color or different colors, and hence forming an image of high quality on the intermediate transfer body 12.

Preferably, the application amounts of the treatment liquid and the ink are adjusted as required. For example, it is preferable that the application amount of the treatment liquid is changed in accordance with the recording medium to which the image is transferred, in order to adjust properties, such as viscoelasticity, of the aggregate formed when the treatment liquid and the ink are mixed.

The solvent removal unit 20 is disposed on the downstream side of the ink ejection unit 16 in terms of the direction of rotation of the intermediate transfer body 12. The solvent removal unit 20 includes a solvent removal roller 32, which faces the roller 26A across the intermediate transfer body 12. The solvent removal roller 32 is constituted by a porous material in the shape of a roller, and it is disposed in such a manner that it abuts against the recording surface 12a of the intermediate transfer body 12. Other modes involve a method which removes excess solvent from the intermediate transfer body 12 by means of an air knife, or a method which removes the solvent by heating and evaporating it, or the like. In these modes for solvent removal, the mode that does not use heating is preferable. In the method that applies heat to the surface of the intermediate transfer body or the aggregate on the intermediate transfer body and thereby drives off the solvent, there may be a case where the aggregate is excessively heated and thereby the solvent is excessively driven off, so that the viscoelasticity of the aggregate suitable for the transfer is not maintained, and the transfer characteristics are deteriorated as a result. Moreover, heating the intermediate transfer body may affect the ejection characteristics of the inkjet head.

In the solvent removal unit 20, the solvent on the recording surface 12a of the intermediate transfer body 12 is removed by means of the solvent removal roller 32. Therefore, even if a large amount of the treatment liquid is deposited onto the recording surface 12a of the intermediate transfer body 12, the solvent is removed by the solvent removal unit 20 and consequently, there is no transfer of large quantities of solvent (dispersion medium) to the recording medium 34, in the transfer unit 18. Therefore, even in cases where paper is used as the recording medium 34, the characteristic problems of aqueous solvents, such as curling and cockling, do not occur.

The removal of the excess solvent from the ink aggregate by means of the solvent removal unit 20 also accomplishes condensation and increased internal aggregating force of the aggregate. The cohesion of the resin particles in the aggregate is thus enhanced, and the internal aggregating force of the aggregate is increased before the transfer. Since the ink aggregate is effectively condensed through the solvent removal, then the transferred image with improved fixing properties and gross properties can be formed on the recording medium.

It is not always necessary that the solvent is completely removed by means of the solvent removal unit 20. When the ink aggregate is excessively condensed through excessive solvent removal, there may be a case where the adhesiveness of the ink aggregate becomes too large on the intermediate transfer body, and the pressure required for the transfer is too large. Therefore, it is rather preferable that a small amount of the solvent remains even after the solvent removal, for the purpose of maintaining the viscoelasticity of the ink aggregate suitable for the transfer. When the small amount of the solvent remains after solvent removal, the remaining solvent separates from the ink aggregate and forms a thin liquid film between the ink aggregate and the intermediate transfer body since the ink aggregate is hydrophobic while nonvolatile components (chiefly, organic solvent components such as glycerin) of the solvent are hydrophilic. Thus, the adhesiveness of the ink aggregate on the intermediate transfer body is reduced, and it is preferable in terms of transfer characteristics.

The transfer unit 18 is disposed on the downstream side of the solvent removal unit 20 in terms of the rotation direction of the intermediate transfer body 12. The transfer unit 18 includes a pressurization roller 36 at a position facing the roller 26B across the intermediate transfer body 12. A heater 37 (corresponding to a “heating device”) is provided in the pressurization roller 36, and the heater 37 raises the temperature of the circumferential surface of the pressurization roller 36. The recording medium 34 is conveyed from the left-hand side to the right-hand side in FIG. 1, in such a manner that it passes between the intermediate transfer body 12 and the pressurization roller 36. When the medium passes between the intermediate transfer body 12 and the pressurization roller 36, the front surface side of the recording medium 34 makes contact with the recording surface 12a of the intermediate transfer body 12, and pressure is applied by the pressurization roller 36, from the rear surface side of the recording medium 34, thereby causing the image formed on the recording surface 12a of the intermediate transfer body 12 to be transferred onto the recording medium 34.

In the present embodiment, it is preferable that the heating device is arranged only in the transfer unit of the intermediate transfer body. By means of this composition, it is possible to prevent the problems of excess heat load and excess solvent removal from the ink aggregate, which may arise in the case of entire surface heating of the transfer body. Moreover, the ink aggregate is heated at the transfer unit 18, and major part of the solvent in the ink aggregate is removed. The internal aggregating force of the ink aggregate is thereby increased through not only the physical condensation of the ink aggregate caused by pressurization but also the enhanced cohesion of the resin particles caused by heating, during a short period of time from immediately before the transfer to the transfer in the region where the transfer body is in contact with the pressurization/heating roller.

In this case, since the solvent can be promptly removed by means of heat, then the transfer rate is not deteriorated even if the solvent removal is not carried out before the transfer. However, it is preferable to remove the solvent in advance, since the amount of solvent to be evaporated is reduced and the condensation is more effective, and moreover there is also a benefit that the heat load on the transfer unit can be reduced. Further, since the ink aggregate is effectively condensed by heating, then the transferred image with improved fixing properties and gross properties can be formed on the recording medium.

The transfer temperature and the transfer pressure may be optimized in accordance with the type of the recording medium, print conditions, and the like.

Heating temperature during the transfer is preferably set to a temperature not lower than the minimum film formation temperature (MFT) of the resin emulsion contained in the ink. When the ink aggregate is heated to a temperature not lower than the MFT of the resin emulsion, the cohesion speed of the resin caused by heating during the transfer is highly increased compared to the case of a temperature lower than the MFT. In this case, the MFT of the resin emulsion contained in the ink is preferably not higher than 70° C., more preferably not higher than 50° C., and even more preferably not higher than 30° C. The lower the MFT of the resin emulsion, the lower the required heating temperature, and an image can be transferred at low temperature.

A releasing layer may be provided on the surface of the intermediate transfer body 12. Since the releasing surface thus formed has a low surface energy and high releasing properties, then the transfer rate is further improved. In the present embodiment, the transfer rate is sufficient even if the releasing surface is not formed; however, the releasing layer is preferably provided on the intermediate transfer body in terms of cleaning burden. The releasing surface described here is a surface having a critical surface tension of not greater than 30 mN/m and/or a surface on which water assumes a contact angle of not less than 75°.

Preferred examples of material of the surface for the intermediate transfer body 12 include: a polyurethane resin, a polyester resin, a poly styrene resin, a polyolefin resin, a polybutadiene resin, a polyamide resin, a polyvinylchloride resin, a polyethylene resin, a polyfluoride resin, and a polyimide resin.

The cleaning unit 22 is disposed on the downstream side of the transfer unit 18 in terms of the direction of rotation of the transfer body 12, and on the upstream side of the treatment liquid ejection unit 14 in terms of the direction of rotation of the transfer body 12. The cleaning unit 22 includes a cleaning roller 38, which is provided in a position facing the roller 26C across the intermediate transfer body 12 and is disposed so as to abut against the recording surface 12a of the intermediate transfer body 12, thereby removing the residual matter, and the like, which is left on the recording surface 12a of the intermediate transfer body 12 after the transfer.

The cleaning roller 38 may be made of a flexible and porous member, which cleans the surface of the intermediate transfer body 12 (recording surface 12a) while being impregnated with cleaning liquid from a cleaning liquid deposition device, or a brush may be provided on the surface of the cleaning roller 38 and dirt may be removed from the surface of the intermediate transfer body 12 with the brush, while depositing cleaning liquid onto the surface of the intermediate transfer body 12. Alternatively, residual material on the surface of the intermediate transfer body 12 may be wiped away by providing a flexible blade on the surface of the cleaning roller 38. Making the linear speed of the surface of the cleaning roller 38 slower or faster than the linear speed of the surface of the intermediate transfer body 12, rather than the same speed, enables the removal rate of the residual matter to be increased. This is because the speed differential between the surface of the cleaning roller 38 and the surface of the intermediate transfer body 12 generates a shearing force at the surface of the intermediate transfer body 12, and this causes the residual matter to be removed effectively.

In the present embodiment, the image fixing unit 24 may be provided as required, in order to reliably fix the ink aggregate on the recording medium after the transfer.

The image fixing unit 24 is disposed on the recording medium output side of the transfer unit 18 (the right-hand side in FIG. 1). The image fixing unit 24 includes two fixing rollers 40A and 40B, arranged at the front and rear surfaces of the recording medium 34, and by heating and pressurizing the image having been transferred to the recording medium 34 by means of these fixing rollers 40A and 40B, it is possible to increase the fixing characteristics of the recording image on the recording medium 34. It is preferable that one of the fixing rollers 40A and 40B is a pressurization roller and the other is a heat roller, but the present invention is not limited to this composition.

In the present embodiment, a heating device (not shown) may be provided that heats the recording medium 34 before the recording medium is conveyed to the transfer unit 18.

If the recording medium 34 is heated to a desired transfer temperature just before the recording medium 34 comes in contact with the ink aggregate directly, then heat transfer is more reliably completed in a short period during the transfer-nipping. Moreover, the ink aggregate reliably comes into contact with the surface of the recording medium by heating the recording medium to the desired transfer temperature in advance, compared to the case where the recording medium is heated during the transfer-nipping only.

By heating the recording medium 34 to a temperature not lower than the MFT of the resin emulsion in advance, it is possible to further increase the speed of cohesion of the resin induced by heat during the transfer, and when the ink aggregate comes into contact with the recording medium during the transfer-nipping, the ink aggregate quickly melts and flows into depressions or capillaries on the surface of the recording medium, thereby increasing the adhesiveness of the ink aggregate onto the recording medium due to the anchor effects caused by the increase in contact area. Consequently, the transfer can be reliably carried out and the transferred image having improved fixing properties can be formed on the recording medium.

The above-described benefits can be obtained more effectively by condensing the ink aggregate through the solvent removal. Moreover, in the case of heating the transfer unit, it is also possible to achieve an effect in that the recording medium is kept to a constant temperature by setting the heating temperature of the transfer unit to the heating temperature of the recording medium.

The heating temperature of the recording medium can be freely adjusted in accordance with the type of the recording medium 34, and the viscoelasticity of the ink aggregate can be controlled by means of this temperature adjustment.

If the recording medium 34 is regular paper, high-quality paper, and the like, in which there is considerable surface roughness due to pulp fiber and the large anchor effect is expected between the ink aggregate and the recording medium, then it is possible to render the good fixing properties to the ink aggregate on the recording medium such as regular paper, high-quality paper, and the like, by controlling the viscoelasticity of the ink aggregate by means of adjusting not only the heating temperature of the transfer unit but also the heating temperature of the surface of the recording medium that directly makes contact with the ink aggregate during the transfer.

If the recording medium 34 is coated paper, and the like, whose surface is smooth, then it is possible to render the improved fixing properties to the ink aggregate on the recording medium after the transfer, by adjusting the viscoelasticity of the ink aggregate to relatively hard compared to the case where the recording medium has large surface roughness.

Next, the structure of the recording head 30 is described.

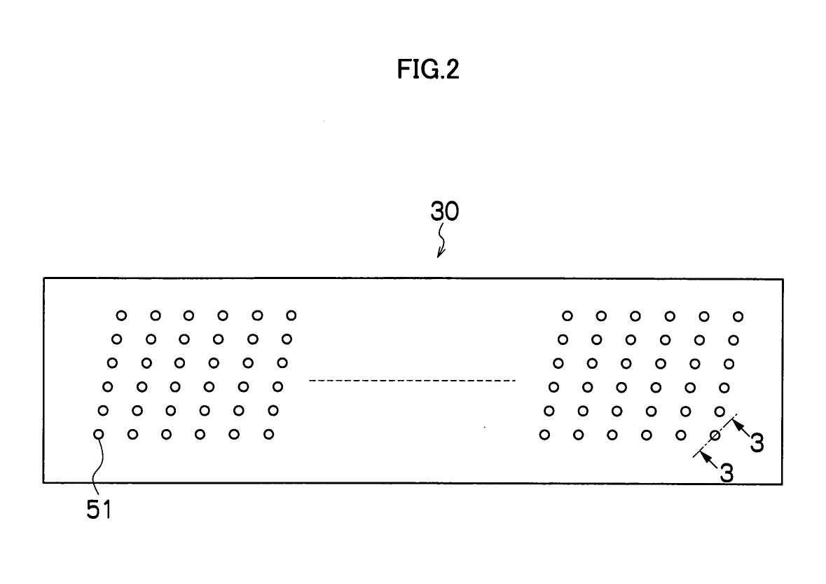

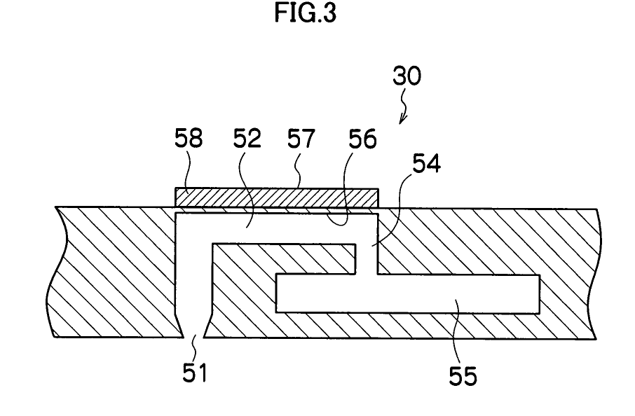

FIG. 2 is a plan diagram showing the ejection face of the recording head 30, and FIG. 3 is a partial cross-sectional diagram along line 3-3 in FIG. 2. In FIG. 2, the lengthwise direction of the head 30 corresponds to the direction of the obverse-reverse of the sheet containing FIG. 1. The recording head 30 according to the present embodiment is constituted by a full line head formed with a plurality of ejection ports (nozzles) 51 through a length corresponding to the maximum recording width of an image formed on the intermediate transfer body 12. As shown in FIG. 2, the nozzles 51 are arranged two-dimensionally (in a matrix configuration) following the lengthwise direction of the head and an oblique direction which is not perpendicular to the lengthwise direction of the head, and it is possible to achieve high-resolution image recording on the intermediate transfer body 12 by means of this high-density arrangement of the nozzles.

As shown in FIG. 3, pressure chambers 52 connected to the nozzles 51 are provided in the recording head 30, for the respective nozzles 51. A supply port 54 is formed at one end of each pressure chamber 52, and the pressure chamber 52 is connected to a common flow channel 55 by means of this supply port 54. A prescribed liquid (treatment liquid or ink of one of the respective colors) is accumulated in the common flow channel 55, and the liquid is supplied from the common flow channel 55 to the pressure chambers 52.

One wall of each pressure chamber 52 (the upper face in FIG. 3) is constituted by a diaphragm 56, and a piezoelectric element 58 is mounted on the diaphragm 56 at a position corresponding to the pressure chamber 52. An individual electrode 57 is provided on the upper surface of the piezoelectric element 58. In the present embodiment, the diaphragm 56 is constituted by a conductive material, and it also serves as a common electrode for the piezoelectric elements 58.

By adopting this composition, when a drive voltage is applied to the piezoelectric element 58, a pressure is applied to the liquid in the pressure chamber 52 due to the displacement of the piezoelectric element 58, thereby causing a droplet of the liquid to be ejected from the nozzle 51. After ejection, the liquid is supplied to the pressure chamber 52 from the common flow channel 55.

The present embodiment is a mode using a piezoelectric system, in which ejection is performed by using the piezoelectric elements 58, but the implementation of the present invention is not limited to this, and it is also possible, for example, to adopt a thermal system which performs ejection by using electrical-thermal converting elements, such as heaters, or other types of ejection systems.

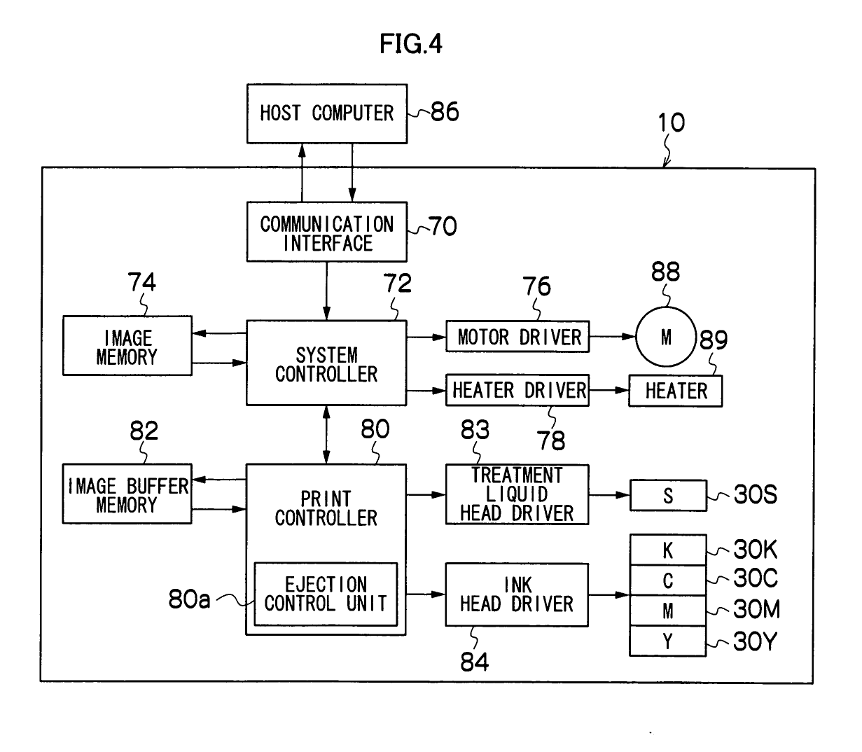

FIG. 4 is a principal block diagram showing the system configuration of the inkjet recording apparatus 10. The inkjet recording apparatus 10 includes a communication interface 70, a system controller 72, an image memory 74, a motor driver 76, a heater driver 78, a print controller 80, an image buffer memory 82, a treatment liquid head driver 83, an ink head driver 84, and the like.

The communication interface 70 is an interface unit for receiving image data sent from a host computer 86. A serial interface or a parallel interface may be used as the communication interface 70. A buffer memory (not shown) may be mounted in this portion in order to increase the communication speed.

The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is a control unit for controlling the various sections, such as the communications interface 70, the image memory 74, the motor driver 76, the heater driver 78, and the like. The system controller 72 is constituted by a central processing unit (CPU) and peripheral circuits thereof, and the like, and in addition to controlling communications with the host computer 86 and controlling reading and writing from and to the image memory 74, or the like, it also generates a control signal for controlling the motors 88 of the various units and the heater 89.

The motor driver (drive circuit) 76 drives the motor 88 in accordance with commands from the system controller 72. The heater driver 78 drives the heater 89 in accordance with commands from the system controller 72.

The print controller 80 is a control unit having a signal processing function for performing various treatment processes, corrections, and the like, in accordance with the control implemented by the system controller 72, in order to generate a signal for controlling printing from the image data in the image memory 74. The print controller 80 supplies the print control signal (dot data) thus generated to the head drivers 83 and 84. Prescribed signal processing is carried out in the print controller 80, and the ejection volume and the ejection timing of liquid droplets from the recording heads 30 (30S, 30K, 30M, 30C, 30Y) are controlled via the head drivers 83 and 84, on the basis of the image data. By this means, prescribed dot sizes and dot positions can be achieved. The ejection control that is characteristic of the present invention is implemented by the ejection control unit 80a of the print controller 80.

The print controller 80 is provided with the image buffer memory 82; and image data, parameters, and other data are temporarily stored in the image buffer memory 82 when image data is processed in the print controller 80. The aspect shown in FIG. 4 is one in which the image buffer memory 82 accompanies the print controller 80; however, the image memory 74 may also serve as the image buffer memory 82. Also possible is an aspect in which the print controller 80 and the system controller 72 are integrated to form a single processor.

The head drivers 83 and 84 (the treatment liquid head driver 83 and the ink head driver 84) respectively generate drive signals for driving the piezoelectric elements 58 (see FIG. 3) of the corresponding recording heads 30 (30S, 30K, 30C, 30M, 30Y), on the basis of the dot data supplied from the print controller 80, and they supply the generated drive signals to the piezoelectric elements 58, accordingly. A feedback control system for maintaining constant drive conditions for the recording heads 30 may be included in the head drivers 83 and 84.

In the present embodiment, the treatment liquid is applied on the intermediate transfer body 12 by ejecting the treatment liquid from the treatment liquid head 30S; however, the method of applying the treatment liquid is not limited to this in carrying out the present invention.

In a modified embodiment, it is possible to use an application roller in place of the treatment liquid head 30S to coat the intermediate transfer body 12 with the treatment liquid. The treatment liquid can readily be applied substantially all over the intermediate transfer body 12 including an image formation region where the ink droplets are deposited. In this modified embodiment, the treatment liquid is preferably applied on the intermediate transfer body 12 to a thickness of 1 μm to 5 μm. A device may also be provided which uniforms the thickness of the treatment liquid on the intermediate transfer body 12. The examples of this device includes: a device which is provided with an air knife; and a device in which a member having a sharp edge is arranged above the intermediate transfer body 12 at a distance equal to a specified thickness of the treatment liquid.

The above-described embodiment concerns the mode where the first liquid is the ink containing the coloring material, but the implementation of the present invention is not limited to this. For example, there is also a mode where the first liquid contains metal, and a wiring pattern is transferred and formed onto the recording medium.

As described above, in the image forming apparatus including: the intermediate transfer body which carries the ink image; the treatment liquid application unit which applies the treatment liquid on the intermediate transfer body; the ink ejection unit which ejects the ink to form the ink image on the treatment liquid applied on the transfer body; and the transfer unit which transfers the ink image formed on the intermediate transfer body, to the recording medium, the ink contains the coloring material and the resin emulsion having the ionic group, the treatment liquid creates a pH change by making contact with the ink, and the aggregating action is induced in the coloring material and the resin emulsion having the ionic group, and since the pH differential between the ink and the treatment liquid is 3 or greater, then it is possible to achieve a sufficiently fast speed of the aggregation reaction between the ink and the treatment liquid, as well as strengthening the aggregating force of the ink aggregate.

Consequently, the image quality on the intermediate transfer body is improved, and it is possible to achieve good transfer from the intermediate transfer body to the recording medium, even when using a high-speed system. Therefore, no residual material is left on the intermediate transfer body after the transfer and it is possible to reduce the burden of cleaning the intermediate transfer body after the transfer. Moreover, it is possible to achieve good ink fixing properties and good gloss, on the recording medium.

If the pH differential between the treatment liquid and the ink is less than 3, then sufficient concentration diffusion of the base composition (OH⁻ ions) from the treatment liquid may not be achieved, and a sufficient aggregating action may not be obtained. In this case, the reduction of the surface charge of the coloring material particles and the resin particles caused by the neutralization is delayed, and the suspension of the coloring material particles and the resin particles in the ink is not sufficiently destabilized. Consequently, image disturbance on the transfer body occurs due to the flow of the coloring material on the transfer body, and transfer error occurs due to the fact that the aggregate has insufficient aggregating force at the transfer stage. If, on the other hand, the pH differential between the treatment liquid and the ink is 3 or more, then sufficient concentration diffusion occurs and a desirable aggregating action is achieved.

### EXAMPLES

The present invention is described in more specific terms below with reference to practical examples.

### Treatment Liquid

Treatment liquids 1 to 4 having the compositions described below were used.

### (Treatment Liquid 1)

diethylene glycol: 20 wt %
2-pyrrolidone-5-carboxylic acid: 4.5 wt %
sodium hydroxide: 1 wt %
Olfine E1010 (manufactured by Nissin Chemical Industry): 1 wt %
deionized water: 73.5 wt %

### (Treatment Liquid 2)

magnesium nitrate hexahydrate: 15 wt %
glycerin: 15 wt %
Olfine E1010: 1 wt %
deionized water: 69 wt %

### (Treatment Liquid 3)

PAA-HCl-3L (resin component 50%; manufactured by Nitto Boseki): 15 wt %
diethylene glycol: 20 wt %
Olfine E1010: 1 wt %
deionized water: 64 wt %

### (Treatment Liquid 4)

diethylene glycol: 20 wt %
2-pyrrolidone-5-carboxylic acid: 2.5 wt %
sodium hydroxide: 1 wt %
Olfine E1010: 1 wt %
deionized water: 75.5 wt %

### Ink

### (Manufacture of Pigment Dispersion)

The components listed below were mixed in the composition as shown below so that the total quantity was 500 parts by weight, and 2,2′-Azobis(2,4-dimethyl)valeronitrile of 2 parts by weight was added as a polymerization initiator, thereupon carrying out sufficient nitrogen gas substitution to yield a resin mixture liquid:
stearyl methacrylate: 20 wt %
styrene macromer: 5 wt %
styrene: 10 wt %
polypropylene glycol (9) methacrylate: 10 wt %
methacrylic acid: 10 wt %
2-mercaptoethanol: 0.1 wt %
   where the details of “styrene macromer” and “polypropylene glycol (9) methacrylate” are as follows:

styrene macromer: manufactured by Toa Gosei, product name: AS-6 (styrene homopolymerization macromer), number average molecular weight: 6000, polymerizable functional group: methacryloyloxy group; and

polypropylene glycol (9) methacrylate: manufactured by Nippon Oil & Fats, product name: Blemmer PP-500 (number of added moles of propylene oxide: 9).

Next, methyl ethyl ketone of 500 parts by weight was heated to a temperature of 75° C. while agitated in a nitrogen atmosphere. The above-described resin mixture liquid was added dripwise over a period of 4 hours, while agitated at 75° C. Reaction continued for a further 6 hours while agitated at 75° C. Thereupon, the reaction product was cooled naturally to a temperature of 25° C., and then diluted by adding methyl ethyl ketone in such a manner that the solid content became 50%, thereby obtaining a resin dispersion having an average molecular weight of 19,000.

The copolymer dispersion (solid content: 50%) thus obtained of 15 parts by weight was taken and neutralized by adding 5 mol/L aqueous sodium hydroxide of 2 parts by weight, and Pigment Red 122 (product name: CROMOPHTAL Jet Magenta DMQ, manufactured by Ciba Specialty Chemicals) of 7.5 parts by weight was then added and the mixture was kneaded for 2 hours to 8 hours, according to requirements, by means of a roll mill. The kneaded mixture was dispersed in deionized water of 100 parts by weight. The organic solvent was removed completely from the dispersion thus obtained, under reduced pressure at 60° C., and the dispersion was further concentrated by removing water, thereby obtaining an aqueous dispersion of pigment-containing vinyl polymer particles having a solid content concentration of 20 wt %, which was used as the pigment dispersion in the inks as follows.

Inks 1 to 7 having the compositions described below were used.

### (Ink 1)

pigment dispersion: 20 wt %
Aron HD-5 (manufactured by Toa Gosei; MFT: 30° C.): 5 wt %
glycerin: 8 wt %
diethylene glycol : 8 wt %
Olfine: 1 wt %
deionized water: 38 wt %

### (Ink 2)

pigment dispersion: 40 wt %
glycerin: 8 wt %
diethylene glycol: 8 wt %
Olfine: 1 wt %
deionized water: 43 wt %

### (Ink 3)

pigment dispersion: 40 wt %
Ultrasol B400-H (manufactured by Ganz Chemical; MFT: 20° C.): 5 wt %
glycerin: 8 wt %
diethylene glycol: 8 wt %
Olfine: 1 wt %
deionized water: 38 wt %

### (Ink 4)

pigment dispersion: 40 wt %
Joncryl 537 (manufactured by Johnson Polymer; MFT: 50° C.): 5 wt %
glycerin: 8 wt %
diethylene glycol: 8 wt %
Olfine: 1 wt %
deionized water: 38 wt %

### (Ink 5)

pigment dispersion: 40 wt %
Joncryl 780 (manufactured by Johnson Polymer; MFT: 70° C.): 5 wt %
glycerin: 8 wt %
diethylene glycol: 8 wt %
Olfine: 1 wt %
deionized water: 38 wt %

### (Ink 6)

pigment dispersion: 40 wt %
Joncryl 7610 (manufactured by Johnson Polymer; MFT: 80° C.): 5 wt %
glycerin: 8 wt %
diethylene glycol: 8 wt %
Olfine: 1 wt %
deionized water: 38 wt %

### (Ink 7)

pigment dispersion: 40 wt %
Aron HD-5 (manufactured by Toa Gosei; MFT: 30° C.): 2 wt %
glycerin: 8 wt %
diethylene glycol: 8 wt %
Olfine: 1 wt %
deionized water: 41 wt %

### Image Forming Apparatus

The image forming apparatus having a composition including the intermediate transfer body 12, the treatment liquid ejection unit 14, the ink ejection unit 16 and the transfer unit 18 of the inkjet recording apparatus 10 shown in FIG. 1 was used. The specific composition and the conditions of the image forming apparatus are described below.

A silicone rubber sheet SR series (manufactured by Tigers Polymer) having a thickness of 0.5 mm was used as the intermediate transfer body 12.

A minimum composition in which the treatment liquid ejection unit 14 and the ink ejection unit 16 each have one recording head was adopted, and a piezoelectric type of head, the PX-G920 (manufactured by Epson), was used as the recording head.

In the present examples, recording was carried out by firstly depositing droplets of the treatment liquid (having a droplet size of 7 picoliters (pl)) onto the intermediate transfer body, and subsequently, depositing droplets of the ink (having a droplet size of 7 pl) onto the treatment liquid. A cyan ink was used.

The pressure in the transfer unit was 1 MPa, the conveyance speed was set to 250 mm/s or 500 mm/s, and when heating, a suitable heating temperature was set.

When carrying out the solvent removal, a roller-shaped inorganic porous body (sintered alumina material) was abutted against the intermediate transfer body and the solvent was absorbed.

Tokubishi Art paper (manufactured by Mitsubishi Paper Mills) was used as the recording medium. When heating before transfer, a heater was used and a suitable heating temperature was set.

### Evaluation

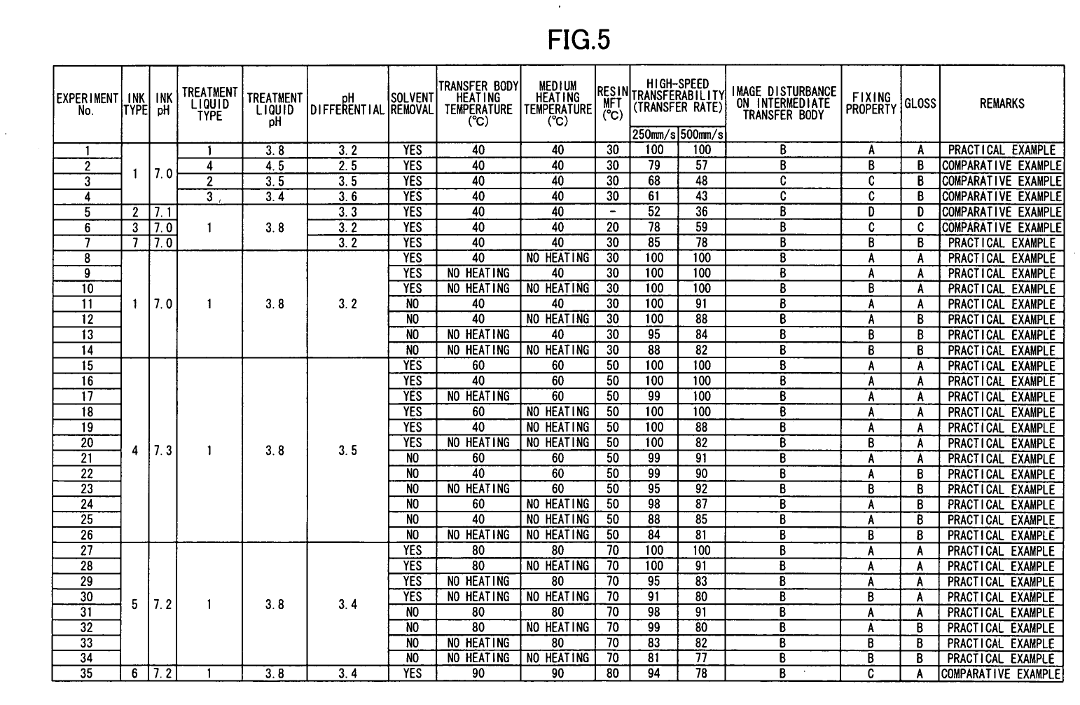

For combinations shown in FIG. 5 of the inks and the treatment liquids described above, the image disturbance on the intermediate transfer body, the suitability for high-speed transfer, the fixing characteristics, and the gloss of the image were evaluated on the basis of the following evaluation standards. The results are shown in FIG. 5.

### (Image Disturbance on Intermediate Transfer Body)

Ten dots were recorded onto the endless belt-shaped intermediate transfer body, and evaluation was made by counting the number of dots on the intermediate transfer body that were disturbed after conveying the intermediate transfer body for ten seconds at a speed of 500 mm/s. The judgment criteria for evaluating whether or not the dot shape had been disturbed was based on whether or not the dot maintained a circular shape. For example, if a dot had assumed an elliptical shape, then it was regarded to have been disturbed. The criteria were as follows.

A: all dots preserve circular shape

B: dot shape disturbance observed in one to four dots

C: dot shape disturbance observed in at least five dots

### (High-speed Transfer Suitability)

The recording was carried out for 10×10=100 dots (corresponding to 3 pl), transfer was carried out under the conditions described above, and the number of dots transferred to the recording medium while preserving their dot shapes was counted and was defined as the transfer rate. The conveyance speed was set to two levels: 250 mm/s or 500 mm/s. Here, the conveyance speed was changed between the two levels in order to evaluate whether or not a satisfactory transfer rate could be achieved, even if the required time from the mixing of the treatment liquid and the ink upon deposition until the transfer of same (the travel time from the image formation unit to the transfer unit) was halved.

### (Fixing Characteristics)

A solid cyan image was recorded onto the intermediate transfer body, the image was transferred onto the recording medium under the conditions described above, and an art paper (Tokubishi Art, manufactured by Mitsubishi Paper Mills) was placed on the transferred solid image on the recording medium and rubbed back and forth five times while a load of 1.5 kg/cm² was applied. The resulting state of peeling of the coloring material was evaluated by a visual assessment. Moreover, the optical density of the cyan part was measured in the rubbing area, by means of a spectrodensitometer (X-Rite 938 manufactured by X-Rite), before and after carrying out the rubbing test, and an evaluation was also made on the basis of the remaining ratio of coloring material calculated from the measurement results (namely, the ratio of the cyan density after the rubbing test to the cyan density before the rubbing test). The criteria were as follows. In the embodiment of the present invention, it is desirable that the remainder ratio of the coloring material is not less than 90%.

A: coloring material remainder ratio 95% or more (no detachment of coloring material at all observed in rubbed part)

B: coloring material remainder ratio 90% or more and less than 95% (hardly any detachment of coloring material observed in rubbed part; no problem when viewed with naked eye)

C: coloring material remainder ratio 85% or more and less than 90% (detachment of coloring material recognized in rubbed part, but within tolerable range)

D: coloring material remainder ratio less than 85% (some parts of the white surface of the recording medium were exposed; outside tolerable range)

### (Gloss of Image)

A solid image was recorded on the intermediate transfer body, the image was transferred under the conditions described above, and the gloss of the transferred solid image on the recording medium was measured at 20° according to JIS Z8741, using a digital variable angle gloss meter (UGV-5D manufactured by Suga Test Instruments), and the minimum value was recorded. The criteria were as follows. In the embodiment of the present invention, it is desirable that the 20° gloss is 75 or above.

A: the 20° gloss of 80 or above

B: the 20° gloss of 75 or above and less than 80

C: the 20° gloss of 70 or above and less than 75

D: the 20° gloss of less than 70

### (Results)

As shown in FIG. 5, in the cases where dot shape disruption occurred in the evaluation of image disturbance on the intermediate transfer body, it is considered that after depositing and mixing of the treatment liquid and the ink, the ink aggregate did not have sufficient aggregating characteristics, and therefore the unreacted coloring material flowed on the intermediate transfer body during conveyance. In the practical examples according to the present invention, which used the mechanism of aggregation by pH change, no disturbance of the dot shape was observed.

It is considered that the better the transfer rate, the greater the expectation of good transfer without transfer errors and transfer non-uniformities, and the better the suitability for high-speed transfer. In the conditions of the practical examples according to the present invention, the transfer rate was good, and the ink aggregate seemed to have acquired a sufficient internal aggregating force in the period from the mixing of the treatment liquid and the ink until their transfer to the recording medium in the form of the ink aggregate, in the transfer unit. Moreover, even better results were obtained in terms of the suitability for high-speed transfer in the cases of carrying out operation of the solvent removal, heating in the transfer unit (desirably, to the minimum film formation temperature of the resin or higher), and/or preliminary heating of the recording medium to the minimum film formation temperature of the resin or higher. Furthermore, by carrying out these operations in combination, then due to synergic effects, it was possible to obtain even more satisfactory results than when using a single means.

Under the conditions of practical examples according to the present invention, it was possible to obtain fixing characteristics at or above a level which presents no problem visually. Moreover, even better results were obtained in terms of the fixing characteristics in the cases of carrying out operation of the solvent removal, heating in the transfer unit (desirably, to the minimum film formation temperature of the resin or higher), and/or preliminary heating of the recording medium to the minimum film formation temperature of the resin or higher. Furthermore, by carrying out these operations in combination, then due to synergic effects, it was possible to obtain even more satisfactory results than when using a single means.

It is further considered from the evaluation results shown in FIG. 5 that it was possible to impart excellent gloss to the image by using the ink containing the sufficient concentration of the resin particles. Moreover, it was possible to obtain even more satisfactory gloss by carrying out the solvent removal. It is thought that removing solvent helps the condensation of the resin particles in the ink aggregate to act more effectively. Moreover, it was possible to impart even more satisfactory gloss by also carrying out heating of the transfer unit and the recording medium, to the minimum film formation temperature of the resin or higher.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming apparatus, comprising:
an intermediate transfer body on which an ink image is formed;
a treatment liquid application unit which applies treatment liquid on the intermediate transfer body;
an ink ejection unit which ejects ink to be deposited on the treatment liquid to form the ink image; and
a transfer unit which transfers the ink image formed on the intermediate transfer body to a recording medium, wherein:
the ink contains coloring material and an emulsion of resin having an ionic group;
the treatment liquid changes a pH of the ink when making contact with the ink so that the coloring material and the emulsion of resin having the ionic group aggregate; and
a pH differential between the ink and the treatment liquid is not less than 3.

2. The image forming apparatus as defined in claim 1, further comprising a solvent removal unit which removes solvent from the ink image formed on the intermediate transfer body.

3. The image forming apparatus as defined in claim 1, wherein the transfer unit includes a heating device.

4. The image forming apparatus as defined in claim 3, wherein a heating temperature in the transfer unit is not lower than a minimum film formation temperature of the emulsion of resin having the ionic group.

5. The image forming apparatus as defined in claim 1, wherein the recording medium is heated to a temperature not lower than a minimum film formation temperature of the emulsion of resin having the ionic group, before being conveyed to the transfer unit.

6. The image forming apparatus as defined in claim 1, wherein a minimum film formation temperature of the emulsion of resin having the ionic group is not higher than 70° C.

7. An ink set for an image forming apparatus of an intermediate transfer type which forms an image on a recording medium by forming an ink image on an intermediate transfer body and then transferring the ink image formed on the intermediate transfer body to the recording medium, the ink set comprising:
an ink which contains coloring material and an emulsion of resin having an ionic group; and
a treatment liquid which changes a pH of the ink when making contact with the ink so that the coloring material and the emulsion of resin having the ionic group aggregate,
wherein a pH differential between the ink and the treatment liquid is not less than 3.

8. The ink set as defined in claim 7, wherein a minimum film formation temperature of the emulsion of resin having the ionic group is not higher than 70° C.
